(19) United States
(12) Patent Application Publication
(10) Pub. No.: US 2013/0217926 A1
(43) Pub. Date: Aug. 22, 2013

(54) COMPOSITE MEMBRANE

(71) Applicants: Yanshuo Li, Dalian (CN); Xinlei Liu, Dalian (CN); Weishen Yang, Dalian (CN)

(72) Inventors: Yanshuo Li, Dalian (CN); Xinlei Liu, Dalian (CN); Weishen Yang, Dalian (CN)

(73) Assignees: Dalian Institute of Chemical; BP P.L.C.; Physics, Chinese Academy of Sciences

(21) Appl. No.: 13/805,506

(22) PCT Filed: Jun. 25, 2010
(86) PCT No.: PCT/CN2010/000947

§ 371 Date: Jan. 4, 2013

(51) Int. Cl. B01D 69/12

(52) U.S. Cl. CPC B01D 69/12
USPC 568/913; 210/500.27; 210/650; 210/500.25; 427/203; 427/244

(57) ABSTRACT

A method of forming a composite membrane (104) comprising particles of a filler material (110) in a polymer matrix (114) is described. In an example, the method includes the steps of: providing a support surface (100); applying particles of filler material onto the support surface to form an array of particles (110) and interspaces (112) between the particles; and applying matrix material to the filler material on the support surface such that matrix material (114) is applied in interspaces. By applying the particles to the surface, followed by the application of the matrix material, in some examples a more desirable distribution of the particles in the final membrane may be achieved.

This invention relates to composite membranes and to methods for their manufacture. Aspects of the invention relate to organic-inorganic membranes, and in particular examples to membranes for use in pervaporation. In examples of the invention, the composite membranes are used in the recovery of alcohol, for example butanol, from solutions.

Alcohols, for example butanols, are widely used as biofuels, solvents, and as precursors for chemical synthesis. With currently known fermentation techniques for the production of butanol, the final concentration of butanols in fermentation broths is generally low, for example only about 20 g/L of iso-butanol in some examples. Distillation is a traditional recovery option for butanols, but is very energy intensive, in particular in view of the low yield of butanol.

A reason for the low yield of butanol is that iso-butanol is product toxic to fermentation cells above a critical concentration and the fermentation stops above this concentration. Simultaneous separation of product from the fermentation reactor can make the fermentation proceed in a substantially continuous manner, reducing downtime and improving the productivity of the reactor.

From an energy requirement perspective, pervaporation is presently considered to be one of the more attractive options for effecting separation of product. Pervaporation involves the the separation of mixtures of liquids by partial vaporization through a membrane. The separation of the components is based on a difference in transport rate of individual components through the membrane and the efficiency of the separation depends on the chemical and physical properties of the membrane.

The main materials of pervaporative membranes for recovering alcohols currently studied include polydimethylsiloxane (PDMS) and poly(1-trimethylsilyl-1-propyne) (PTMSP). PDMS is currently the benchmark membrane material due to its performance in the recovery of alcohols. The reported butanol-water separation factor for a PDMS membrane ranges from 2.4 to 44.0, with a flux of several tens of g/m²/h.

There is a need for an improved membrane technology for separation of butanol from fermentation broth. There is also a need for improved membranes for use in the separation of other organic materials. The improved membranes would preferably exhibit improved flux and/or selective separation compared with known membrane technologies.

It has been reported that the addition of zeolite into a PDMS membrane as a filler can increase the selectivity of the membrane by forming a mixed matrix membrane. Mixed matrix membranes using zeolites with particle sizes in the micron range are described in Journal of Membrane Science. 192 (2001) 231-242. For such membranes, however, the thickness of composite membranes was inherently higher than that of most unfilled membranes. As a consequence, the thickness of composite membranes was inherently high and the absolute flux remained low. The development of nano-sized zeolites provides an opportunity to prepare thin filled polymer membranes. However, the tendency of particle agglomeration is inversely related to particle size, and hence, preparation of high-quality nanocomposite membranes is hampered (Chemical Communications. 24 (2000) 2467-2468.). In order to enhance the performance of mixed matrix membranes, it is desirable to develop a method for fabricating homogeneous composite membranes, for example composite membranes including nano-sized particles.

According to a first aspect of the invention there is provided a method of forming a composite membrane comprising particles of a filler material in a polymer matrix, the method including the steps of: providing a support surface; applying particles of filler material onto the support surface to form an array of particles and interspaces between the particles; and applying matrix material to the filler material on the support surface such that matrix material is applied in interspaces.

By first applying the particles to the surface, followed by application of the matrix material, a more desirable distribution of the particles in the final membrane can be achieved. In particular, in examples of the invention, agglomeration of particles in the membrane structure can be reduced or avoided compared with methods in which a liquid composition including the particles and the matrix material is applied to the support surface. It is believed that by reducing the agglomeration of the particles, improved membrane performance can be achieved.

In examples described herein, silicalite-1 nano-crystals and PDMS are combined in a manner which is different to the conventional method of dispersing the zeolite in the polymeric casting solution.

Preferably at least some of the interspaces are substantially filled by the matrix material. By filling the interspaces, it is thought that the performance of the membrane can be improved through the reduction or elimination of voids in the membrane. In some examples, substantially all of the interspaces will be filled by the matrix material.

In some examples, the matrix material may form a layer or coating on the layer of particles on the support surface. In some cases, the layer or coating substantially or completely covers the particles on the support surface. In other examples, particles may be present at the matrix material surface.

It will be understood that in some examples, further layers or treatments may be applied to the matrix material after application.

The particles may be present in the membrane at an amount of at least 50 wt %, for example at least 60 wt %.

By using the method of the examples of the invention, it has been found that in some cases significant amounts of particulate material, for example as high as 73 vol. % or 82 wt %, may be included in the membrane material without significantly reducing the mechanical properties of the membrane material.

Preferably the average particle size of the particles is less than 100 nm and/or larger than 10 nm. The particle size may be characterized for example by DLS, TEM or SEM or other appropriate technique.

The particles may include one or more different materials. Preferably some or substantially all of the materials of the particles is a porous material.

In some examples, a wide range of materials may be used for the particles. The particles may include one or more different materials. Advantageously, the particles comprise particles of one or more inorganic materials. The particles may include a zeolite or other inorganic particles for example SiO₂, Al₂O₃, and/or metal oxides.

The matrix material may include a silicone elastomer.

The thickness of the membrane may be for example between from about 50 nm to about-5000 nm.

The application of the particles may include the step of dip coating the support into a liquid containing particles. After application of the particles they may be calcined

The application of the matrix may include the step of dip coating the support including the particles into a liquid including a matrix material.

The matrix material may include for example one or more matrix precursors.

The dip-coating step may be carried out several times.

The particles may include nano-crystals, and /or the particles are prepared by a method including a step of hydrothermal forming of the particles from a solution.

The method may further include curing applied matrix material.

In preferred examples, the support surface is provided by the internal surface of a capillary. Preferably the capillary has a generally circular section. The capillary support may have an external diameter of less than 10 mm, preferably less than 5 mm, for example 4 mm. A small outside diameter may give a high packing density. The capillary wall may have a thickness of less than 1 mm, for example about 0.6 mm. Thus the transport resistance of the capillary is relatively low. The support surface may comprise alumina, which can give a capillary having a relatively high mechanical stability.

In application of the invention, preferably a membrane module comprises a plurality of capillaries, each having a matrix and filler particles on an internal surface of the capillary. According to a further aspect of the invention there is provided a membrane comprising a capillary having an internal surface, and a composite membrane material on the internal surface, the composite membrane material including particles in a matrix. Preferably the membrane includes a plurality of capillaries.

Compared with for example tubular supports, hollow fibres can have the advantage of a relatively high packing density. However, such hollow fibres having small diameter are difficult to seal and the transport resistance can be large in the core side. By providing capillary supports for the material, in some examples a high packing density can be obtained, with relatively high mechanical stability and/or a relatively low transport resistance.

According to the invention there is also provided a membrane made using steps of a method described herein. Preferably the membrane comprises a pervaporation membrane.

Also provided by the invention is a membrane assembly including a support surface and a membrane on the support surface, the membrane including:

particles of material on the surface; and

matrix material extending into interspaces between adjacent particles of material.

The membrane may include at least 50 wt %, preferably at least 60 wt % of the particles based on the weight of the particles and matrix on the support surface.

The average particle size of the particles may be less than 100 nm and/or larger than 10 nm.

The particles may include one or more different materials. Preferably some or substantially all of the materials of the particles is a porous material.

The particles may include a zeolite or other inorganic particles (for example SiO₂, Al₂O₃, and metal oxides). In examples, the particles comprise silicalite, for example silicalite-1 crystals.

The matrix may include a silicone elastomer. For example, the matrix may comprise PDMS. In examples below, a substantially homogeneous silicalite-PDMS nanocomposite membrane is fabricated with low agglomeration of particles and few voids between nano-crystal and the PDMS phase. Other materials could be used for the matrix. For example, the matrix material may include poly(1-trimethylsilyl-1-propyne) (PTMSP) and/or poly(ether-block-amide) (PEBA) and/or other appropriate material.

The thickness of the membrane may be for example between from about 50 nm to about 5000 nm.

The total flux of the membrane may be for example between from about 0.5 to about 25 kgm⁻² h⁻¹.

The selectivity of the membrane to iso-butanol in an aqueous solution may be at least 10 (the selectivity being determined as the weight ratio of iso-butanol to water in the permeate/the weight ratio of iso-butanol to water in the feed.)

Also provided by the invention is a method of separating alcohol from an aqueous mixture, the method including using a membrane described herein.

Also provided by the invention is the use of a membrane described herein in a fermentation process.

The invention also provides a membrane and/or a method of manufacture of a membrane being substantially as herein described preferably having reference to one or more of the accompanying figures.

Features described herein may be combined in any appropriate combination. Features described in relation to one aspect of the invention may be combined with one or more features of other aspects of the invention, as appropriate. For example, features of an apparatus aspect may be combined with features of a method aspect.

Embodiments of the invention will now be described by way of example having reference to the accompanying drawings of which:

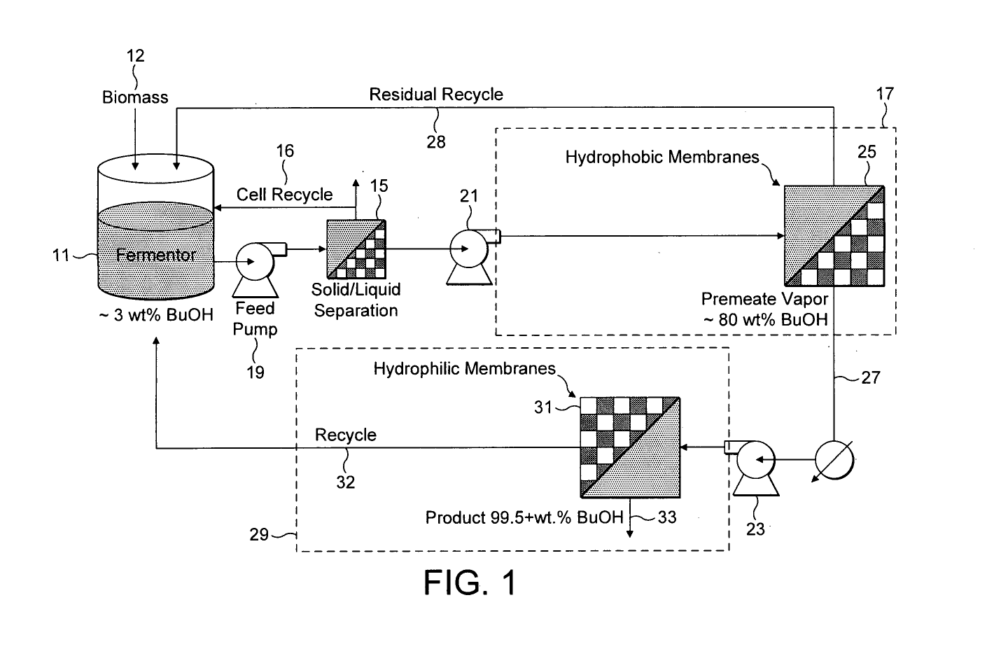

FIG. 1 shows schematically an apparatus and method for the production of iso-butanol from biomass;

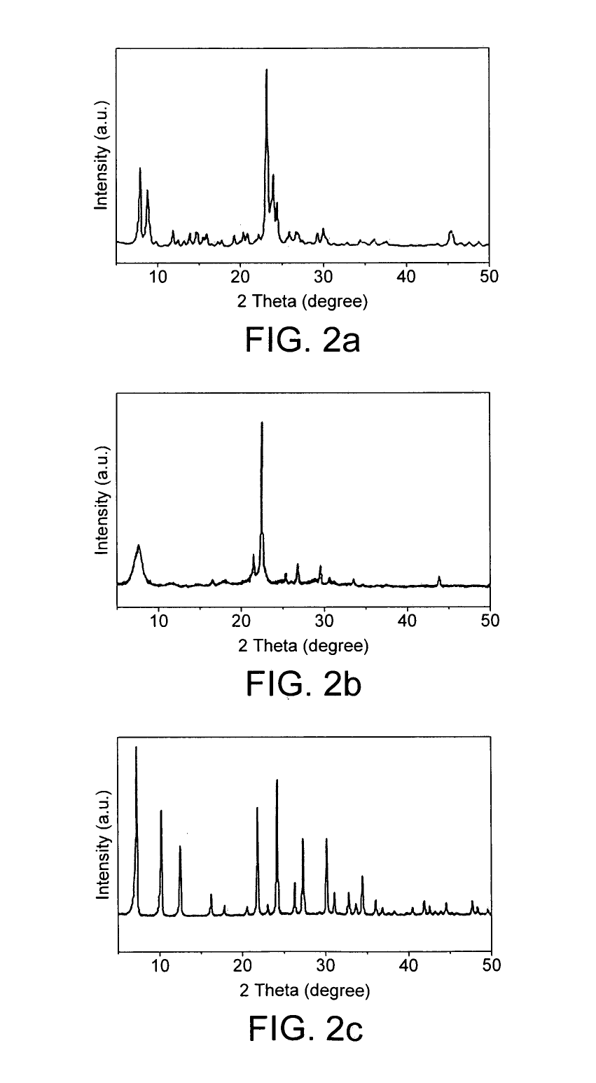

FIGS. 2a to 2c shows X-ray diffraction patterns of silicalite-1 (FIG. 2a), beta (FIG. 2b), and LTA (FIG. 2c) type zeolites;

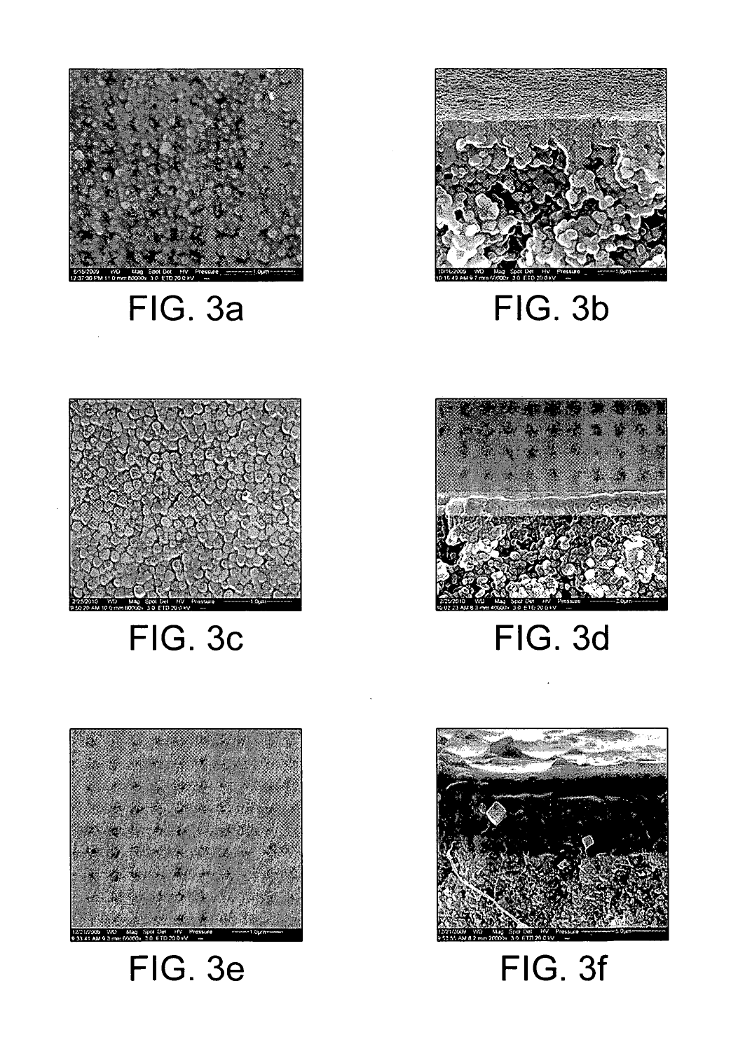

FIGS. 3a to 3f show SEM images of membranes M1, M2 and M4;

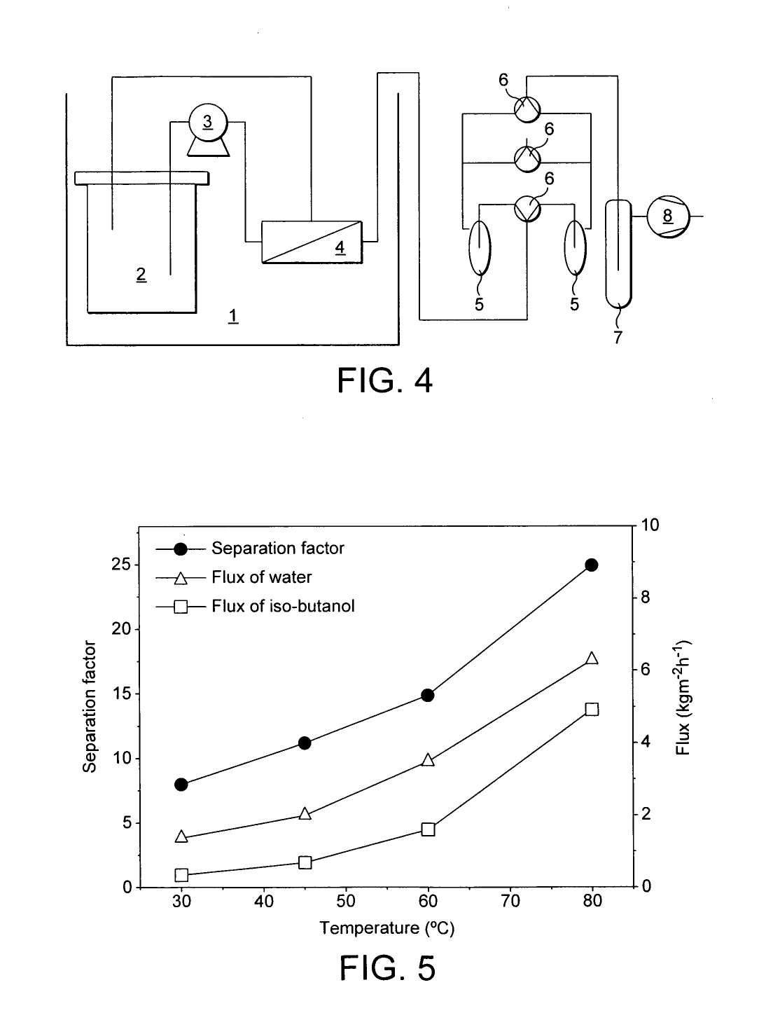

FIG. 4 shows a schematic diagram of a pervaporation apparatus;

FIG. 5 shows the effect of temperature on separation factor and flux;

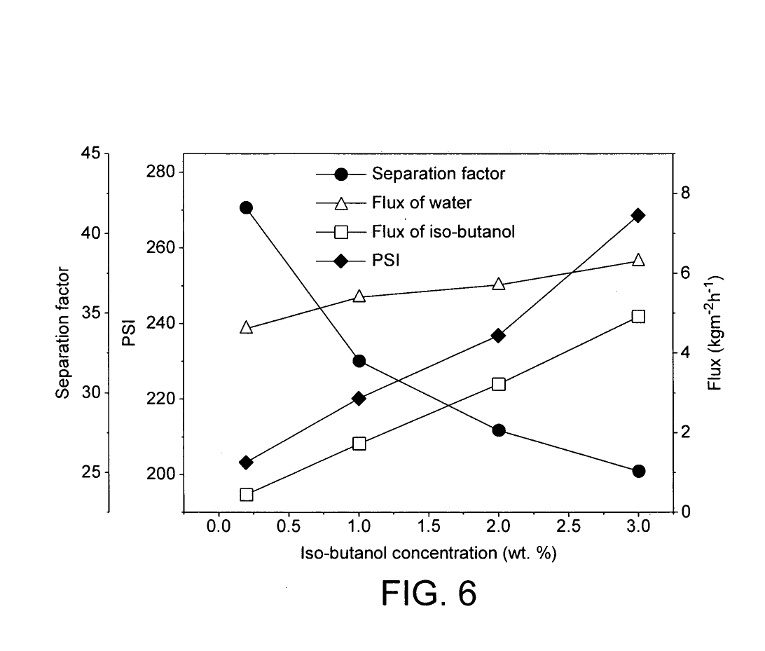

FIG. 6 shows the effect of iso-butanol concentration on separation factor and flux of water and iso-butanol; and

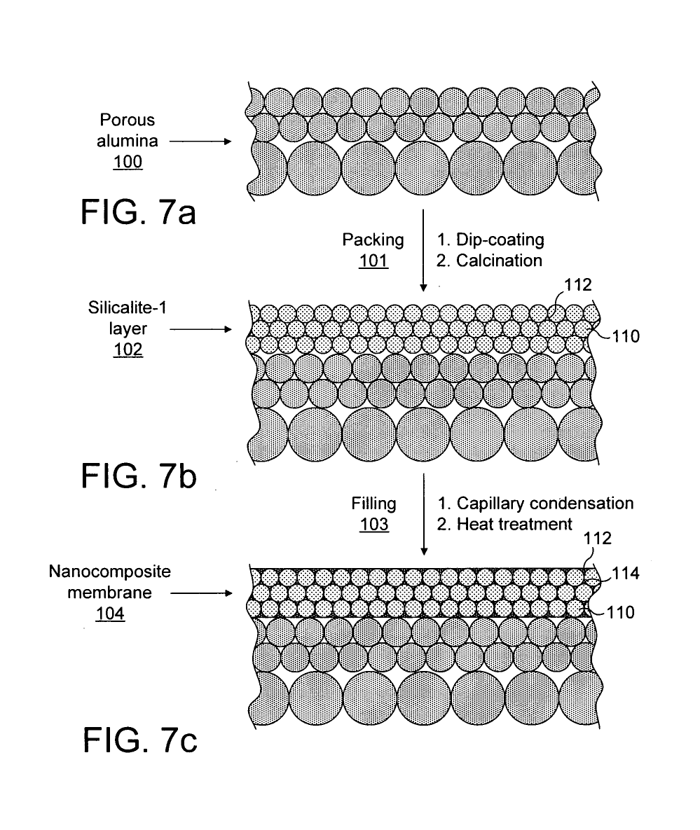

FIGS. 7a to c show schematically the steps in an example of the forming of the nanocomposite membrane.

FIG. 1 shows schematically an example of an apparatus and method for production of iso-butanol from biomass. The apparatus includes a fermentor 11 into which the biomass 12 is fed. Products from the fermentor 11 are fed via a first pump 19, an initial solid/liquid separator 15, and a second pump 21 to a first separation membrane unit 17. A recycle path 16 is provided from the initial solid/liquid separator 15 to the fermentor 11. Pumps 19, 21 and 23 are used to pump the product though the system. In the first separation membrane unit 17, a hydrophobic pervaporation membrane unit 25 is arranged to concentrate the butanol in the product stream. In examples, the permeate vapour 27 from the hydrophobic pervaporation membrane 25 may include for example about 80 wt % iso-butanol. The residual material may be recycled via recycle path 28 to the fermentor 11. The permeate vapour 27 may be fed using a further pump 23 to a further separation stage 29 provided downstream of the first separation membrane unit 17. For example, the further separation stage 29 may include a hydrophilic membranes 31 for the dehydration of iso-butanol solution of the permeate vapour 27 to obtain in some examples a product stream 33 including more than 99.5% fuel iso-butanol. A further recycle path 32 is provided from the further separation stage 29 to the fermentor 11.

The following examples describe methods for the preparation of membranes, for example for use as a hydrophobic pervaporation membrane 25 in a system for the production of butanol from biomass. While examples of the invention described herein relate to the recovery of butanol from a fermentation process, it should be understood that the invention is not restricted to membranes for use in such a process. Aspects of the invention find general application in the pervaporative recovery of organic compounds from their aqueous solution. Aspects of the invention may find application in relation to the separation of for example ethanol from fermentation broth, low concentration volatile organic compounds in water, such as phenol in waste water.

Also described are the membranes obtained, and their characteristics and performance in the separation of organic compounds from solution.

### EXAMPLE 1

In this example, a silicalite-PDMS composite membrane (M1) was synthesized. The membrane includes silicalite particles within a PDMS matrix.

### Preparation of Silicalite-1 Nano-Crystals

Silicalite-1 nano-crystals were hydrothermally synthesized at relatively mild conditions by a modified recipe (Advanced Materials. 13 (2001) 1880-1883.). Molar composition of the synthesis solutions was maintained at TPAOH:SiO₂:H₂O:EtOH=9:25:408:100.

20 g of tetrapropylammonium hydroxide TPAOH (Aldrich, 20 wt. %) was mixed with 2.044 g H₂O with stirring. After formation of a homogenous solution, 11.386 g tetraethyl orthosilicate TEOS (Kermel, AR) was added and stirred at room temperature for 24 h to form a clear solution.

Subsequently, the clear solution was transferred to a Teflon (RTM)-lined autoclave, heated to 90° C. and kept there statically for 24 h. After hydrothermal synthesis, the resulting product was centrifuged at 15,000 rpm for 1 h and washed with water using ultrasonic treatment for 1 h for several cycles until the pH value reached 8 to 10. The pre-prepared nano-crystals in the suspension had MFI structure.

### Preparation of Support Tubes

Alumina capillary tubes (Hyflux Ltd., Singapore) were used as the membrane support. The tubes had 3.7 mm outside diameter, 2.4 mm inside diameter, 10 cm length and approximately 40 nm pore size were sonicated in an ultrasonic bath for 5 minutes to remove impurities physically adsorbed on their surfaces. The treated tubes were then dried in an oven at 50° C. and then the outer surface of the support was protected with Teflon (RTM) tape.

The prepared silicalite-1 nano-crystals were dispersed in double de-ionised (DDI) water (0.2 wt. %) and sonicated for at least lh before the dip-coating process.

The dip-coating was carried out at 20° C. The prepared support tubes were dipped into the prepared nano-crystal dispersion and then withdrawn at a 1.4 mm/min withdrawing speed to coat the nano-crystals onto the inner surface of the support. After drying 12 h at 20° C. and 12 h at 50° C., the silicalite-1 layer on the tube surface was further calcined with a temperature ramp speed of 0.5° C./min and held at 500° C. for 2 h for removal of templates (TPAOH) occluding in the silicalite-1 structures.

### Preparation of Composite Membrane

To prepare the silicalite-PDMS composite membrane, 1.5 g of PDMS (vinyl terminated) and 0.3 g of its curing agent (methylhydrogen siloxane) (sylgard 184, used as received from Dow Corning Co.) were dissolved in 13.5 g of iso-octane (Kermel, AR) by ultrasonic wave for 20 min.

Then, the prepared support tube was dip-coated into the prepared solution for 10 s and withdrawn with a speed of 1.5 cm/s. After being dried at 20° C. for 10 min, the dip-coating process was repeated. Afterwards, the formed membrane was cured at room temperature for 24 h, 50° C. for 3 h and then held at 50° C. for 19 h under vacuum.

### EXAMPLE 2

In this example, a Beta-PDMS composite membrane (M2) was synthesized.

### Preparation of Zeolite BETA Nano-Crystals

Zeolite Beta nano-crystals were hydrothermally synthesized by a modified recipe (Chemical communications. 3 (2003) 326-327.) from a colloidal precursor solution having the following chemical composition: SiO₂: 2 (TEA)₂O: 11.8 H₂O. The silica source for the preparation of the initial precursors was fumed silica and the alkali source was tetraethylammonium hydroxide (35 wt % in water). These components were mixed under stirring at ambient temperature for 24 h prior to the further hydrothermal (HT) treatment at 100° C. for 8 days. After hydrothermal synthesis, the product was centrifuged at 15,000 rpm for 1 h and washed with water using ultrasonic treatment for 1 h for several cycles until the pH value reached 8-10.

### Preparation of Support Tubes

Alumina capillary tubes (Hyflux Ltd., Singapore) were used as the membrane support. The tubes had 3.7 mm outside diameter, 2.4 mm inside diameter, 10 cm length and ca. 40 nm pore size. The tubes were sonicated in an ultrasonic bath for 5 min to remove impurities physically adsorbed on surfaces. The treated tubes were then dried in an oven at 50° C. The outer surface of the support was protected with Teflon tape.

The prepared BETA nano-crystals were dispersed in DDI water (0.5 wt. %) and sonicated for at least 1 h before dip-coating.

The dip-coating was carried out at 25° C. The prepared support tubes were dipped into the prepared nano-crystal dispersion and then withdrawn at 1.4 mm/min withdrawing speed to coat the nano-crystals onto the inner surface of the support. After drying 12 h at 25° C. and 12 h at 50° C., the BETA layer was further calcined with a temperature ramp speed of 0.5° C./min and kept at 500° C. for 2 h to remove templates in frameworks.

### Preparation of Composite Membrane

The interspaces between the Beta nano-crystals are filled with polydimethylsiloxane (PDMS) phases by the same method as that of M1 of Example 1.

### EXAMPLE 3

In this example, an LTA-PDMS composite membrane (M3) was synthesized.

### Preparation of Zeolite LTA Nano-Crystals

LTA nano-crystals were hydrothermally synthesized by a modified recipe (Science. 283 (1999) 958-960.). Clear aluminosilicate solutions with composition 0.3Na₂O: 11.25SiO₂: 1.8Al₂O₃: 13.4(TMA)₂O: 700H₂O were prepared and stirred at room temperature for 2 days. Subsequently, the clear solution was transferred to a Teflon(RTM)-lined autoclave, heated to 100° C. and kept there for two days under stirring. After hydrothermal synthesis, the product was centrifuged at 15,000 rpm for 1 h and washed with water using ultrasonic for 1 h for several cycles until the pH value of the as-prepared suspensions reached 8-10.

### Preparation of Support Tubes

Alumina capillary tubes (Hyflux Ltd., Singapore) were used as the membrane support. The tubes had a 3.7 mm outside diameter, 2.4 mm inside diameter, 10 cm length and ca. 40 nm pore size) were sonicated in an ultrasonic bath for 5 min to remove impurities physically adsorbed on surface, then dried in an oven at 50° C. The outer surface of the support was protected with Teflon tape.

LTA nano-crystals dispersed in DDI water (0.6 wt. %) were sonicated for at least 1 h before dip-coating.

The dip-coating was carried out at 25° C. The prepared support tubes were dipped into the prepared nano-crystal dispersion and then withdrawn at 1.4 mm/min withdrawing speed to coat the nano-crystals onto the inner surface of the support. After drying for 12 h at 25° C. and 12 h at 50° C., the LTA layer was further calcined with a temperature ramp speed of 0.5° C./min and kept at 500° C. for 2 h to remove templates in frameworks.

### Preparation of Composite Membrane

The interspaces between the LTA nano-crystals were filled with polydimethylsiloxane (PDMS) phases by the same method as that used for M1 in Example 1.

### EXAMPLE 4

In this example, a γ-Al₂O₃-PDMS composite membrane (M4) was synthesized.

### Preparation of γ-Al₂O₃ Nano-Crystals

A boehmite sol was prepared by peptization of a boehmite suspension with 1.6 mol/L HNO₃ at 80° C. under stirring, and aged for 6 h. PVA 72000 and PEG 400 were used as additives of the casting sol. The casting sol contained 2 wt. % PVA 72000, 1% PEG 400 and 0.5 mol/L boehmite.

### Preparation of Support Tubes

The alumina tubes were prepared as in Example 1 up to the dip-coating step. During dip-coating in the sol, the ceramic support was contacted with sol, and kept there for 9 s. After drying for 2 days at room temperature, the γ-Al₂O₃ layer was further calcined with a temperature ramp speed of 0.5° C./min and kept at 600° C. for 2 h (Science in China B. 40 (1997) 31-36.).

### Preparation of Composite Membrane

The interspaces between the γ-Al₂O₃ nano-crystals were filled with polydimethylsiloxane (PDMS) phases by the same method with that of M1.

### EXAMPLE 5

In this example, the characterization of the composite membranes prepared in Examples 1 to 4 (M1-M4) was studied.

### X-ray Diffraction

For membranes M1, M2 and M3, an X-ray diffraction (XRD) pattern was recorded on Rigaku D/MAX 2500/PC (using Cu Kα radiation, λ=0.154 nm at 40 kV and 250 mA). The XRD patterns of silicalite-1, beta, LTA type zeolites are shown in FIGS. 2a to c.

### Scanning Electron Microscopy

The as-made membranes were sputter coated with gold and their morphologies were studied by scanning electron microscopy (SEM, a 200 FEG, FEI Co., 20 kV). FIGS. 3a to f show the SEM images of M1, M2, and M4 as follows: membrane M1 surface (FIG. 3a) and cross section (FIG. 3b); membrane M2 surface (FIG. 3c) and cross section (FIG. 3d); and membrane M4 surface (FIG. 3e) and cross section (FIG. 3f).

The images show novel membrane morphologies different from those of prior membranes. The polymer is seen to fill the interspaces between the inorganic particles and to cover the surface of them uniformly. No voids between the inorganic particles and polymer were observed, suggesting good zeolite-polymer contact.

The as-synthesized silicalite-1 crystals were seen to have an average crystal size of about 80 nm. A substantially smooth and crack-free silicalite-1 layer was seen to coat the inner surface of the alumina capillary support. The silicalite layer was seen to be about 300 nm thick. Before filling with PDMS, templates in the channels of the silicalite-q nano-crystals were removed by calcining at 500 degrees C. During the calcination treatment, it is thought that covalent bonds can be formed among the silicalite-1 nano-crystals and between the silicalite-1 nano-crystals and the support. This rigid assembly of silicalite-1 nano-crystals can act as a zeolitic skeleton for the following construction of the silicalite-PDMS nanocomposite membrane.

In examples of the dip-coating the silicalite-layer with PDMS, the interspaces among the silicalite-1 nano-crystals were substantially completely filled with the polymeric phase. Substantially no voids between the nano-crystals and PDMS phase were observed, suggesting a good zeolite-polymer adhesion. From the SEM top view, the texture of the preformed silicalite-1 layer can still be distinguishable, indicating a very thin layer of PDMS on the zeolite sub-layer in these examples. From cross-sectional views, it can be seen that the thickness of the nanocomposite membrane is almost the same as that of the dip-coated silicalite-1 layer (about 300 nm). The so-obtained nanocomposite membrane has a high zeolite loading of about 74 vol %, as calculated using closest packing model. Membranes described can offer the possibility of achieving a high flux for pervaporation separation of butanol without significant membrane swelling occurring.

### EXAMPLE 6

In this example, the properties of the composite membranes prepared in Examples 1 to 4 (M1-M4) were measured under different conditions.

The pervaporation apparatus utilized in this example is shown in FIG. 4.

The pervaporation apparatus includes a feed tank 2 supplying feed via a pump 3 to a membrane module 4 including the pervaporative membrane prepared in one of Examples 1 to 4. The retentate from the membrane module 4 is recycled to the feed tank 2. The permeate from the membrane module 4 is passed to a three-way valve 6 from where it is fed to one of two cold traps 5. Downstream of the traps is arranged further three-way valves 6 and a buffer vessel 7. The permeate is drawn through the apparatus by a vacuum pump 8.

The properties of the as-synthesized tubular membranes were evaluated by pervaporative recovery of iso-butanol from aqueous solution. The effective membrane area was about 7.0 cm² and the permeation side was kept under vacuum. The permeation flux (J) was measured by weighing the condensed permeate: J=W/(At), where W refers to the weight of permeate (kg), A the membrane area (m²), t the time (h) for the sample collection. Permeate and feed concentrations were measured by off-line gas chromatography (GC) (Aligent 7890).

The separation factor was determined as

α_{iso-butanol/water}=(Y_{iso-butanol}/(1−Y_{iso-butanol}))/(Y_{iso-butanol}/(1−X_{iso-butanol})),

where X_{iso-butanol} and Y_{iso-butanol} denote the mass fraction of iso-butanol in the feed and permeate sides, respectively. The pervaporation separation index is defined as PSI=J(α-1). In most cases the pervaporated condensate separated into two phases. In order to measure the concentration of iso-butanol in the condensate, the permeate was diluted with water to generate a single phase.

The pervaporation performance of composite membranes M1 to M4 of Examples 1 to 4 for recovering iso-butanol from its aqueous solution (3 wt. %, 353K) is shown in Table 1.

TABLE 1
pervaporation performance of composite membranes for recovering
iso-butanol from its aqueous solution (3 wt. %, 353K):

| | M1 | M2 | M3 | M4 |
|---|---|---|---|---|
| Total flux (kgm⁻²h⁻¹) | 11.2 | 19.4 | 24.0 | 15.2 |
| Separation factor | 25.0 | 16.7 | 16.1 | 18.2 |

It has been found that the silicalite-1 nano-crystals were distributed onto substrate densely and evenly. Therefore, only the dip-coating conditions for the polymer were manipulated. Table 2 gives the experimental layout and the pervaporation performance of the as-synthesized composite membranes.

TABLE 2
The experimental layout and the pervaporation performance of the as-synthesized
composite membranes towards a iso-butanol/water (3/97, w/w) mixture at 353 K
(primary optimization):

| | Experimental plan | | | | | | |
|---|---|---|---|---|---|---|---|
| | | Dip- | Curing | Dip- | Pervaporation performance | | |
| | PDMS | coating | agent | coating | Separation | Total flux | Iso-butanol |
| No. | (wt. %) | time (s) | (wt. %) | times | factor | (kgm⁻²h⁻¹) | flux (kgm⁻²h⁻¹) |
| 1 | 3 | 10 | 0 | 1 | 1.2 | 293.7 | 10.5 |
| 2 | 3 | 30 | 5 | 2 | 3.3 | 113.9 | 10.5 |
| 3 | 3 | 60 | 10 | 3 | 4.7 | 41.7 | 5.3 |
| 4 | 3 | 120 | 20 | 4 | 16.3 | 28.6 | 9.6 |
| 5 | 10 | 10 | 5 | 3 | 28.8 | 13.2 | 6.2 |
| 6 | 10 | 30 | 0 | 4 | 28.3 | 8.2 | 3.8 |
| 7 | 10 | 60 | 20 | 1 | 5.4 | 18.8 | 2.7 |
| 8 | 10 | 120 | 10 | 2 | 20.1 | 11.4 | 4.4 |
| 9 | 20 | 10 | 10 | 4 | 40.0 | 1.6 | 0.88 |
| 10 | 20 | 30 | 20 | 3 | 37.7 | 1.2 | 0.65 |
| 11 | 20 | 60 | 0 | 2 | 38.9 | 2.2 | 1.2 |
| 12 | 20 | 120 | 5 | 1 | 28.1 | 8.1 | 3.8 |
| 13 | 30 | 10 | 20 | 2 | 43.1 | 1.6 | 0.91 |
| 14 | 30 | 30 | 10 | 1 | 37.1 | 3.2 | 1.7 |
| 15 | 30 | 60 | 5 | 4 | 35.5 | 0.51 | 0.27 |
| 16 | 30 | 120 | 0 | 3 | 36.4 | 1.3 | 0.69 |

PDMS concentration was kept constant at 10 wt. % and further optimization was carried out to obtain high flux and at least moderate separation factor, and the results are listed in Table 3.

TABLE 3
The experimental layout and the pervaporation performance of the
as-synthesized composite membranes towards a iso-butanol/water
(3/97, w/w) mixture at 353 K (further optimization)

| | Experimental plan | | | Pervaporation performance | | |
|---|---|---|---|---|---|---|
| | Curing | Dip- | Dip- | Separa- | | Iso-butanol |
| | agent | coating | coating | tion | Total flux | flux |
| No. | (wt. %) | times | time (s) | factor | (kgm⁻²h⁻¹) | (kgm⁻²h⁻¹) |
| 1 | 0 | 2 | 10 | 4.5 | 55.9 | 6.8 |
| 2 | 0 | 2 | 60 | 1.8 | 63.3 | 3.3 |
| 3 | 0 | 2 | 120 | 2.8 | 50.2 | 4.0 |
| 4 | 0 | 3 | 10 | 4.7 | 23.6 | 3.0 |
| 5 | 0 | 3 | 60 | 14.4 | 15.9 | 4.9 |
| 6 | 0 | 3 | 120 | 13.9 | 12.8 | 3.8 |
| 7 | 0 | 4 | 10 | 16.3 | 8.9 | 3.0 |
| 8 | 0 | 4 | 60 | 25.5 | 4.9 | 2.2 |
| 9 | 0 | 4 | 120 | 23.8 | 8.6 | 3.6 |
| 10 | 10 | 2 | 10 | 26.7 | 13.3 | 6.0 |
| 11 | 10 | 2 | 60 | 20.9 | 8.9 | 3.5 |
| 12 | 10 | 2 | 120 | 20.1 | 11.4 | 4.4 |
| 13 | 10 | 3 | 10 | 26.7 | 3.3 | 1.5 |
| 14 | 10 | 3 | 60 | 22.9 | 2.6 | 1.1 |
| 15 | 10 | 3 | 120 | 26.2 | 4.3 | 1.9 |
| 16 | 10 | 4 | 10 | 32.4 | 7.4 | 3.7 |
| 17 | 10 | 4 | 60 | 22.2 | 7.4 | 3.0 |
| 18 | 10 | 4 | 120 | 25.1 | 8.5 | 3.7 |
| 19 | 20 | 2 | 10 | 30.4 | 13.3 | 6.4 |
| 20 | 20 | 2 | 60 | 23.2 | 9.9 | 4.1 |
| 21 | 20 | 2 | 120 | 26.3 | 8.7 | 3.9 |
| 22 | 20 | 3 | 10 | 27.5 | 3.1 | 1.4 |
| 23 | 20 | 3 | 60 | 29.0 | 3.6 | 1.7 |
| 24 | 20 | 3 | 120 | 25.8 | 7.2 | 3.2 |
| 25 | 20 | 4 | 10 | 26.3 | 2.8 | 1.3 |
| 26 | 20 | 4 | 60 | 27.1 | 4.7 | 2.1 |
| 27 | 20 | 4 | 120 | 32.6 | 5.5 | 2.8 |

Table 4 shows the pervaporation performance of membranes of examples of the present invention compared with the performance of previously reported membranes for butanol recovery. It will be seen that the total fluxes for the previously-reported membranes are generally less than 1.0 kgm⁻² h⁻¹. The surface modified PVDF membrane shows a high total flux, but its selectivity is relatively very low. It is seen that the fluxes of the membranes of examples of the present invention are higher than those of the reported membranes. It is presently thought that the high flux is attributable at least in part to the thin and homogeneous silicalite-PDMS nanocomposite active layer and low support resistance of the capillary. Table 4 gives example pervaporation performance for butanol recovery

| | Feed | Feed | | |
|---|---|---|---|---|
| | concentration | temperature | Total flux | Separation |
| Membrane | (wt. %) | (° C.) | (kgm⁻²h⁻¹) | factor |
| Ge-ZSM-5 | 5^{a} | 30 | 0.02 | 19.0 |
| PTMSP | 2-6^{a} | 25-37 | 0.44-0.59 | 46.3-61.3 |
| Surface | 7.5^{a} | 40 | 2.3 | 5.2 |
| modified | | | | |
| PVDF | | | | |
| PERVAP-1070 | 1^{a} | 70 | 0.34 | 47.8 |
| Silicalite- | 1^{a} | 70 | 0.11-0.61 | 93.0-96.0 |
| PDMS | | | | |
| PDMS | 0.25-5^{a} | 40-70 | 0.07-1.0 | 15.0-50.0 |
| PUR | 1^{b} | 50 | 0.08 | 9.2 |
| PEBA | 1^{b} | 50 | 0.24 | 23.2 |
| Silicalite- | 0.2^{b} | 80 | 5.0 | 41.6 |
| PDMS | 1^{b} | 80 | 7.1 | 32.0 |
| | 2^{b} | 80 | 8.9 | 27.6 |
| | 3^{b} | 80 | 11.2 | 25.0 |
| | | | 10.0^{c} | 17.4^{c} |

^{a}n-Butanol aqueous solution.
^{b}iso-Butanol aqueous solution.
^{c}The template of silicalite-1 was not removed.

It is seen that where the TPA templates occluding in the silicalite-1 nano-crystals are not removed, the as-synthesized composite membrane showed a lower separation factor and a lower flux compared with the corresponding membrane in which the removal was carried out.

The relationship between flux/separation factor and pervaporation temperature with M1 towards 3 wt. % iso-butanol solution is shown in Table 5.

TABLE 5
Effects of pervaporation temperature on membrane (M1) performance:

| Temperature | | Separation |
|---|---|---|
| (° C.) | Total Flux (kgm⁻²h⁻¹) | Factor |
| 30 | 1.7 | 8 |
| 45 | 2.7 | 11.2 |
| 60 | 5.1 | 14.8 |

The total flux was seen to increase with an increase of temperature. See also FIG. 5 which shows that at a feed composition of 3 wt % iso-butanol, both water and iso-butanol fluxes increased with temperature. Without wishing to be bound by any particular theory, this is thought to be due to the increase of mobility of permeating molecules, which is enhanced by the temperature and the higher mobility of the polymer segments, as well as the increase of desorption rate of iso-butanol in silicalite-1 particles. The activation energy of iso-butanol permeation is higher than that for water, so the separation factor increases with an increase of temperature.

The results suggested that the nanocomposite membrane showed little swelling even at higher temperature. This may be due to the effects of space restriction and physical cross-linking by the close-paced silicalite-1 nano-crystals.

The relationship between flux/separation factor and feed concentration with membrane M1 at 80° C. is shown in Table 6.

TABLE 6
Influence of iso-butanol concentration in the feed on membrane (M1)
performance:

| Concentration | Total Flux | Separation |
|---|---|---|
| (wt. %) | (kgm⁻²h⁻¹) | Factor |
| 1 | 7.1 | 32 |
| 3 | 11.2 | 25.0 |
| 5 | 12.3 | 10.5 |

FIG. 6 shows the effect of iso-butanol concentration on separation factor and flux of water and iso-butanol. Without wishing to be bound by any particular theory, it is thought that by increasing the iso-butanol concentration, iso-butanol in the feed phase had more sorption interaction with the membrane phase due to the affinity of iso-butanol being higher than water to the membrane. Furthermore, the sorption of the iso-butanol may increase the free volume and chain mobility of the polymer. Consequently, the diffusion of water through the membrane can be enhanced. Therefore, that the flux increases significantly with an increase in feed iso-butanol concentration is understandable. The denominator term in the selectivity relationship becomes large at high feed iso-butanol concentrations, thus giving low separation factor.

The examples given above are merely for the purpose of illustration and are not to be regarded as limiting the scope of the invention or manner in which it may be practiced. Variations may be made within the scope of the invention.

In summary, examples of the invention provide an organic-inorganic composite membrane. In examples of methods of manufacture of the membranes, the membrane thickness can be adjusted in a relatively wide range, from nano-level to micron-level, and high loadings of inorganic particles greater than 80 vol. % can be obtained. In comparison, known composite membranes generally include less than 50 vol. % of particles. A non-hydrothermal synthesis method can be used to fabricate membranes of the present invention. In examples, firstly inorganic particles are distributed onto a support evenly and densely; secondly, the interspaces between the inorganic particles are filled with polymer phases. Membranes made according to some examples possess high flux and acceptable separation factor for the pervaporative recovery of organic compounds from their aqueous solution.

In examples described, silicalite-1 nano-crystals are deposited onto a porous alumina capillary support using dip-coating technique. A nano-crystal layer is formed on the support following a calcination step. Subsequently, interspaces between the nano-crystals on the surface were at least partly filled with PDMS using capillary condensation effect. Vacuum assisted heat treatment was performed to remove solvent and to facilitate cross-linking among the PDMS chains and between the silicalite-1 nano-crystals and the PDMS chains. In this way, an ultra thin and highly homogenous silicalite-PDMS active layer was substantially uniformly coated onto the thin-walled capillary.

FIG. 7a to c show schematically the steps in the forming of the nanocomposite membrane. A porous alumina support surface 100 of FIG. 7a is subject to dip-coating and calcination shown by the packing step 101 to form a silicalite-1 layer 102 on the surface of the porous alumina 100. The silicalite-1 layer includes an array of particles 110 including interspaces 112 between the particles 110. In a filling step 103, capillary condensation of matrix material 114 and subsequent heat treatment gives rise to the nanocomposite material 104 shown in FIG. 7c. As shown schematically, the matrix material 114 occupies interspaces 112 between the particles 110.

Nanocomposite membranes formed can show a very high flux for extracting low concentration iso-butanol from water. In examples, the membrane possesses very high flux (5.0-11.2 kgm⁻² h⁻¹) and good separation factor (25.0-41.6) for the pervaporative recovery of iso-butanol from aqueous solution (0.2-3 wt. %) at 80° C. The ultra thin (300 nm) and homogeneous silicalite-PDMS nanocomposite active layer and the low support resistance of the capillary may account for this high flux.

1. A method of forming a composite membrane comprising particles of a filler material in a polymer matrix, the method including the steps of:
providing a support surface;
applying particles of filler material onto the support surface to form an array of particles and interspaces between the particles; and
applying matrix material to the filler material on the support surface such that matrix material is applied in interspaces.

2. A method according to claim 1, wherein at least some of the interspaces are substantially filled by the matrix material.

3. A method according to claim 1, wherein the particles are present in the membrane at an amount of at least 50 wt %.

4. A method according to claim 3, wherein the particles are present in the membrane in an amount of at least 60 wt %.

5. A method according to claim 1, wherein the average particle size of the particles is less than 100 nm.

6. A method according to claim 1, wherein the average particle size of the particles is greater than about 10 nm.

7. A method according to claim 1, wherein the particles include a zeolite.

8. A method according to claim1, wherein the particles include one or more of the group comprising SiO₂, A1₂O₃, and metal oxides.

9. A method according to claim 1, wherein the matrix includes a silicone elastomer.

10. A method according to claim 1, wherein the thickness of the membrane is between from about 50 nm and 5000 nm.

11. A method according to claim 1, wherein the application of the particles includes the step of dip coating the support into a liquid containing particles.

12. A method according to claim 1, wherein after application of the particles they are calcined.

13. A method according to claim 1, where the application of the matrix includes the step of dip coating the support including the particles into a liquid including a matrix material.

14. A method according to claim 1, wherein the particles include nano-crystals.

15. A method according to claim 1, wherein the particles are prepared by a method including a step of hydrothermal forming of the particles from a solution.

16. A method according to claim 1, further including curing applied matrix material.

17. A membrane made using steps of a method according to claim 1.

18. A membrane assembly including a support surface and a membrane on the support surface, the membrane including:
particles of material on the surface; and
matrix material extending into interspaces between adjacent particles of material.

19. A membrane according to claim 17, wherein the membrane includes at least 50 wt %, preferably at least 60 wt % of the particles based on the weight of the particles and matrix on the support surface.

20. A membrane according to claim 17, wherein the average particle size of the particles is less than 100 nm and/or larger than 10 nm.

21. A membrane according to claim 17 wherein the particles include a zeolite.

22. A membrane according to claim 17, wherein the particles include a silicalite, for example silicalite-1 crystals.

23. A membrane according to claim 17, wherein the particles include one or more materials selected from the group comprising SiO₂, A1₂O₃, and metal oxides.

24. A membrane according to claim 17, wherein the matrix includes a silicone elastomer.

25. A membrane according to claim 17, wherein the matrix includes PDMS.

26. A membrane according to claim 17, wherein the thickness of the membrane is between from about 50 nm and 5000 nm.

27. A membrane according to claim 17, wherein the total flux of the membrane is between from about 0.5 to 25 kgm⁻² h⁻¹.

28. A membrane according to claim 17, wherein the selectivity of the membrane to iso-butanol in an aqueous solution is at least 10.

29. A membrane according to claim 17, wherein the support surface comprises an internal surface of a capillary having an external diameter of less than 10 mm, preferably less than 5 mm.

30. A membrane comprising a capillary having an internal surface, and a composite membrane material on the internal surface, the composite membrane material including particles in a matrix.

31. A method of separating alcohol from an aqueous mixture, the method including using a membrane according to claim 17.

32. A method according to claim 31, wherein the alcohol includes butanol, for example iso-butanol.

33. Use of a membrane according to claim 17 in a fermentation process.
